(19) United States
(12) Patent Application Publication
(10) Pub. No.: US 2026/0042597 A1
(43) Pub. Date: Feb. 12, 2026

(54) A HOLLOW ROTO-MOULDED ARTICLE

(71) Applicant: OMNI COMPOSITE TANK LIMITED, Hong Kong (CN)

(72) Inventors: Daniel Christopher RODGERS, Sydney, New South Wales (AU); Luke Philip DJUKIC, Sydney, New South Wales (AU); Adrian Y. KONG, Sydney, New South Wales (AU); Nimal Kumar BALASUBRAMANI, Sydney, New South Wales (AU)

(21) Appl. No.: 19/100,479

(22) PCT Filed: Aug. 3, 2023
(86) PCT No.: PCT/AU2023/050726

§ 371 Date: Jan. 31, 2025

(30) Foreign Application Priority Data
Aug. 3, 2022 (AU) 2022902179

(51) Int. Cl. B65D 88/06; B29C 41/04; B29C 41/20; B29C 70/30; F17C 1/06; F17C 13/06

(52) U.S. Cl. CPC B65D 88/06; B29C 41/04; B29C 41/20; B29C 70/30; F17C 1/06; F17C 13/06; F17C 2201/0109; F17C 2203/0619; F17C 2203/066; F17C 2203/0663; F17C 2205/0305; F17C 2209/2145; F17C 2209/232

(57) ABSTRACT

A hollow roto-moulded article, having an inner wall defining an interior of the article and integrally formed structure with the inner wall, the integrally formed structure protruding away from the interior of the article, the article formed of a first layer including one or more thermoplastic polymers, and a second layer including one or more fibrous materials.

### FIELD OF THE INVENTION

The present invention generally relates to a rotationally moulded (roto-moulded) article. In particular, embodiments of the invention relate to a hollow composite vessel having at least a thermoplastic layer and a fibrous layer. Aspects of the invention also relate to manufacture of the vessel utilising rotational moulding processes. The vessels may find use in the storage and transportation of powders, liquids, gases and cryogenic substances, particularly hazardous substances.

### BACKGROUND OF THE INVENTION

Tanks are widely used for the transportation of materials such as liquids, gases and powders, both hazardous and non-hazardous. For the transportation of hazardous materials the tanks must meet a number of local and international regulations.

Tanks for the transportation of hazardous materials are generally constructed from metal, which imparts structural strength, and are typically lined with a resilient liner to protect the metal from the corrosive nature of the tank contents.

However, lined metal tanks have a number of disadvantages, including their excessive weight, which increases transportation costs, and the possibility over time that the liner material becomes degraded due to contact with the tank contents, or detached from the inner wall of the metal tank, necessitating liner repair or replacement.

In addition, most tanks require a nozzle for filling, emptying and/or monitoring purposes. Conventionally, nozzles are integrated into tanks by cutting a hole in a suitable location of the tank and welding or otherwise clamping on a prefabricated nozzle.

It is desirable to provide an improved tank which overcomes or ameliorates one or more of the disadvantages or problems of the prior art described above, or which at least provides an alternative useful choice.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In a first aspect, the present invention provides a hollow roto-moulded article, having an inner wall defining an interior of the article and integrally formed structure with the inner wall, wherein the integrally formed structure protrudes away from the interior of the article, the article formed of a first layer including one or more thermoplastic polymers, and a second layer including one or more fibrous materials.

Preferably, the one or more fibrous materials is at least partly infiltrated with the one or more thermoplastic polymers. In such an embodiment, an advantageous multilayer structure is produced that includes a substantially thermoplastic inner/first layer, with a substantially fibrous second layer. The fibrous second layer can act as a suitable coupling layer adapted to enable further layers to be formed therewith. The thermoplastic inner layer can act as a barrier layer that is substantially impervious to material contacting the interior of the article. Furthermore, the integrally formed structure of the article is seamlessly integrated into the article with this same multilayer structure. Thus, there are no weld lines or joints present between the article and the integrally formed structure.

The roto-moulded article when having only said first and second layers may be referred to herein as a thermoplastic polymer/fibrous material composite (or similar).

In an embodiment, the structure is configured to provide fluid communication between the interior of the article and an environment exterior of the article. Preferably, the structure includes one or more nozzles. Advantageously, the or each nozzle is seamlessly integrated into the article with the same multilayer structure. The or each nozzle may respectively form one or more nozzles of the article. In an alternative embodiment, the or each nozzle is configured to receive one or more component parts that form respective one or more nozzles of the article. In such an embodiment, the or each nozzle may facilitate attachment of said one or more component parts to form the respective nozzles of the article.

The or each nozzle may include a nozzle body having, at or towards a first end thereof, a nozzle base formed with the inner wall of the article and, and at or towards a second end thereof, a nozzle opening configured to provide said fluid communication between the interior of the article and the environment exterior of the article. In embodiments where the nozzle is configured to receive one or more component parts that form the nozzle of the article, said nozzle opening is configured to provide said fluid communication between the interior of the article and the nozzle of the article, whereby the nozzle of the article is in fluid communication with the environment exterior of the article. In an embodiment, the nozzle body may be of substantially tubular form. The nozzle body may include an inner wall defining a channel, the channel configured to provide fluid communication between the interior of the article and the nozzle opening. The channel may have a substantially constant transverse cross-section along a substantial length of the channel. Preferably, the channel may be of substantially circular shape in transverse cross-section. However, in other embodiments, the channel may be of another shape in transverse cross-section, such as square, oval, elliptical, triangular. Alternatively, the channel may have a varying transverse cross-section along a substantial length of the channel.

The inner wall of the nozzle body may be arranged substantially parallel to a longitudinal axis of the nozzle. Alternatively, the inner wall of the nozzle body may not be arranged substantially parallel to a longitudinal axis of the nozzle. For example, the inner wall of the nozzle body may have inner side wall surfaces that converge inwardly (i.e. are convex). In an embodiment, at least a portion of the inner wall of the nozzle body may be angled with respect to the longitudinal axis of the nozzle, such that the channel is wider at an exterior facing end of the channel. In an embodiment, said angled portion of the inner wall is located at an exterior end of the channel. In an embodiment, said angled portion of the inner wall coincides with a substantial portion of the inner wall. In another embodiment, said angled portion of the inner wall is a chamfered surface at the exterior end of the channel. In an embodiment, said angled portion of the inner wall is angled at between about 1° and about 90° with respect to the longitudinal axis of the nozzle. In an embodiment, said chamfered surface is angled at between about 1° and about 90° with respect to the longitudinal axis of the nozzle. In an embodiment, said angled portion of the inner wall defines a sealing surface. In an embodiment, said sealing surface is configured to engage a sealing device. In an embodiment, said sealing surface is configured to accommodate a substantially radially directed load from the sealing device. In an embodiment, said sealing surface is configured to accommodate a substantially axially directed load from the sealing device. In an embodiment, said sealing surface is configured to accommodate a load directed at between about 1° and about 89° from the sealing device.

In an embodiment, the or each nozzle includes a base transition portion between the inner wall of the article and the nozzle. Preferably, said base transition portion is substantially curved, thereby defining a smooth transition profile between the inner wall of the article and the nozzle. A radius of curvature of the base transition portion may be in the range of about 1 mm to about 1000 mm, or from about 1 mm to about 500 mm, or from about 5 mm to about 1000 mm, or from about 5 mm to about 500 mm, or from about 1 mm to about 100 mm, or from about 5 mm to about 100 mm. Advantageously, in such an embodiment, the roto-moulded article can be more easily formed during rotational moulding due to the provision of suitably curved surface profiles that enable improved contact time between a mould used to form the article and the one or more thermoplastic polymers and the one or more fibrous materials. As a result, a more consistent bond between the one or more fibrous materials and the one or more thermoplastic polymers is achieved.

In an embodiment, the or each nozzle may include a plurality of nozzle openings at or towards the second end thereof.

Preferably, the or each nozzle includes a flared region adjacent the nozzle opening, whereby a diameter of the flared region is greater than a diameter of at least a portion of the nozzle body. For example, the diameter of the flared region may be greater than a diameter of the nozzle body immediately adjacent the flared region. Advantageously, the present invention provides an integrally formed multilayer structured nozzle with greater width dimension at the nozzle opening. In an embodiment, the flared region includes a flanged end. The flanged end may be configured to facilitate connection of one or more components to the article. For example, the flanged end may be configured to facilitate a fluidly sealed connection between said one or more components and the article. In one embodiment, the flanged end includes an outer wall adapted for engagement with said one or more components. In such an embodiment, the one or more components may bear against the outer wall to thereby form a fluidly sealed connection with the nozzle. In another embodiment, the flanged end includes an inner wall adapted for engagement with said one or more components. In such an embodiment, the one or more components may be received between the inner wall to thereby form a fluidly sealed connection with the nozzle. Preferably, the flanged end is substantially concentric to the nozzle body.

In another embodiment, the or each nozzle includes a flared region between the nozzle opening and the interior of the article, whereby a diameter of the flared region is greater than a diameter of at least a portion of the nozzle body. For example, the diameter of the flared region may be greater than a diameter of the nozzle body immediately adjacent the flared region towards the interior of the vessel and/or towards the nozzle opening. Advantageously, the present invention provides an integrally formed multilayer structured nozzle with greater width dimension between the interior of the vessel and the nozzle opening. In an embodiment, the flared region includes a flange. The flange may be configured to facilitate connection of one or more components to the article. For example, the flange may be configured to facilitate a fluidly sealed connection between said one or more components and the article. In one embodiment, the flange includes an outer wall adapted for engagement with said one or more components. In such an embodiment, the one or more components may bear against the outer wall to thereby form a fluidly sealed connection with the nozzle. In another embodiment, the flange includes an inner wall adapted for engagement with said one or more components. In such an embodiment, the one or more components may be received between the inner wall to thereby form a fluidly sealed connection with the nozzle. Preferably, the flange is substantially concentric to the nozzle body.

Preferably, the or each nozzle includes a nozzle transition portion between the flared region and the nozzle body. For example, the or each nozzle may include a nozzle transition portion between the flanged end and the nozzle body. Preferably, said nozzle transition portion is substantially curved, thereby defining a smooth transition profile between the flared region and the nozzle body. A radius of curvature of the transition portion may be in the range of about 1 mm to about 1000 mm, or from about 1 mm to about 500 mm, or from about 5 mm to about 1000 mm, or from about 5 mm to about 500 mm, or from about 1 mm to about 100 mm, or from about 5 mm to about 100 mm.

In an embodiment, an external surface profile of the or each nozzle is substantially continuous with the inner wall, i.e. a seamless transition between the inner wall of the article, the nozzle body and the flared region. In a preferred embodiment, the base transition portion and the nozzle transition portion are all substantially curved.

In an embodiment, the or each nozzle base is formed substantially with a tangent of the inner wall of the article. In another embodiment, the article includes one or more recesses directed towards the interior of the article and the or each nozzle base is formed in a respective recess. In such an embodiment, the or each nozzle may substantially reside within its respective recess, i.e. substantially the whole nozzle is contained within its respective recess. Such an arrangement may be advantageous when exterior clearance around the article does not permit space for the nozzle or any components associated with the nozzle. In another embodiment, the article includes one or more protrusions directed away from the interior of the article and the or each nozzle base is formed on a respective protrusion.

The article may include reinforcement to increase the strength and/or stiffness of the nozzle. In an embodiment, the or each nozzle is reinforced by a fibre reinforced polymer and one or more thermosetting polymers, wherein the fibre reinforced polymer and the one or more thermosetting polymers are disposed on the second layer about the nozzle and the one or more fibrous materials is at least partly infiltrated with both the one or more thermoplastic polymers and the one or more thermosetting polymers.

In an embodiment, the one or more thermoplastic polymers in the first layer include one or more of ethylene homopolymers, ethylene co-polymers, propylene homopolymers, propylene co-polymers, fluoropolymers, polyvinylchloride, polyvinylidene chloride, polyaryl ether ketone (for example polyether ether ketone) and polyamide.

In an embodiment, the one or more fibrous materials of the second layer comprise one or more of ceramic fibres and polymeric fibres.

In an embodiment, the one or more ceramic fibres in the second layer include one or more of glass, carbon and basalt fibres, or precursors thereof.

The one or more polymeric fibres may comprise one or both synthetic polymers and natural polymers.

The one or more polymeric fibres may comprise one or more of polyamide and polyolefin. Suitable polyolefins include polyethylene and polypropylene.

In an embodiment, the one or more fibrous materials include one or more fabricated textile materials. The one or more fabricated textile materials may include one or more of woven, knitted, and braided materials. The one or more fabricated textile materials comprise yarns of plied strands. In an embodiment, the spacing between at least some yarns of the fibrous material of the second layer is from about 0.01 micron to about 5000 micron, or from about 0.1 micron to about 5000 micron, or between about 1 micron and about 5000 micron, or between about 10 micron and about 5000 micron.

The article may include a third layer including a plurality of filaments selected from one or more of carbon, glass, aramid and basalt filaments, and one or more thermosetting polymers, wherein the second layer is disposed between the first layer and the third layer, and wherein the one or more fibrous materials is at least partly infiltrated with both the one or more thermoplastic polymers and the one or more thermosetting polymers. The third layer may be the same or separate to said reinforcement to increase the strength and/or stiffness of the nozzle.

In an embodiment, the one or more thermosetting polymers of the third layer comprise one or more of vinyl ester, bismaleimide, polyester, polyacrylate, epoxy, and polyurethane.

In an embodiment, the plurality of filaments of the third layer have a filament diameter from about 0.1 micron to about 500 micron, or from about 0.1 micron to about 100 micron, or from about 0.1 micron to about 50 micron, or from about 1 micron to about 20 micron.

In an embodiment, the plurality of filaments of the third layer are in the form of one or more of wound filaments, fabric sections comprising multiple yarns, braided yarns, and chopped fibres.

In an embodiment, the thickness of the first layer is from about 0.1 mm to about 50 mm, the thickness of the second layer is from about 0.1 mm to about 5 mm, and the thickness of the third layer is from about 0.1 mm to about 1000 mm.

In an embodiment, thermoplastic polymer is embedded in gaps between yarns of the fibrous material of the second layer.

In an embodiment, thermoplastic polymer is embedded within the structure of individual yarns of the fibrous material of the second layer.

In an embodiment, tendrils of the fibrous material of the second layer extend from a surface of the yarns into the first layer.

In an embodiment, the thermoplastic polymer is not completely infiltrated across a thickness of the fibrous layer. That is to say, at least a portion of the surface of the fibrous layer is not fully penetrated by the thermoplastic polymer. Preferably, substantially all of the surface of the fibrous layer is not fully penetrated by the thermoplastic polymer.

In an embodiment, the article includes a recess disposed about a periphery of the or each nozzle. The recess may extend through an outer wall of the thermoplastic polymer/fibrous material composite. The recess is configured to facilitate engagement of one or more subsequent layers to the first and second layers. For example, the recess may be configured to facilitate engagement between the hollow thermoplastic polymer/fibrous material composite and one or more subsequent layers. The recess and the nozzle may be coaxial. The recess preferably includes a base adapted to facilitate engagement of the thermoplastic polymer/fibrous material composite to one or more subsequent layers. The base may include an engagement surface on which at least a portion of the one or more subsequent layers may bear. The engagement surface may be substantially planar. The recess may have a depth between about 1 mm and about 200 mm, or from about 1 mm to about 100 mm, or from about 5 mm to about 50 mm. The recess may further include a side wall. The side wall preferably tapers inwardly from the outer wall of the thermoplastic polymer/fibrous material composite to the base of the recess. Advantageously, the inwardly tapered side wall facilitates improved introduction and engagement of the one or more subsequent layers with the thermoplastic polymer/fibrous material composite.

In an embodiment, the one or more component parts that form a nozzle of the article include a first adaptor configured to be connected to a respective one of said nozzles. In an embodiment, said first adaptor includes a flange end. Said first adaptor may be configured to connect to an exterior wall of said nozzle. In an embodiment, said first adaptor is formed of a carbon fibre-reinforced polymer. In an embodiment, an adhesive or other attachment means may be provided between said first adaptor and said exterior wall of said nozzle to facilitate connection therebetween. In an embodiment, said first adaptor is configured to be connected to said reinforcement (e.g. the fibre reinforced polymer). Preferably, said adhesive or other attachment means is provided between said first adaptor and said reinforcement. Preferably, said first adaptor is configured to facilitate connection of external component(s) to the article. For example, said first adaptor may facilitate connection to one or more of pipes, valves, sensors, closures and probes.

In an embodiment, the one or more component parts that form a nozzle of the article include a second adaptor configured to be connected to a respective one of said nozzles. In an embodiment, said second adaptor includes a flange end. Said second adaptor may be configured to connect to an exterior wall of said nozzle. In an embodiment, said second adaptor is formed of a thermoplastic polymer. For example, the thermoplastic polymer may be polyethylene. In an embodiment, the second adaptor is configured to be received at least in part in the channel of the nozzle body. Preferably, the second adaptor is sealingly engaged with the angled portion of the inner wall of the nozzle body, wherein a sealing device can be received between the second adaptor and the angled portion of the inner wall of the nozzle body. In an embodiment, the second adaptor is configured to operatively engage the first adaptor. Preferably, said flanged end of the first adaptor includes an upper engagement surface, and said flanged end of the second adaptor includes a lower engagement surface, wherein the lower engagement surface of the second adaptor is configured to operatively engage with the upper engagement surface of the first adaptor. Preferably, the second adaptor is of substantially the same shape as the first adaptor.

In an embodiment, at least one of the nozzles (or at least one of the nozzles of the article formed of said one or more component parts) is configured to be attached to a closure, wherein said closure prevents fluid communication between the interior of the article and the environment exterior of the article. In an embodiment, said first adaptor is configured to operatively engage with said closure. In an embodiment, said second adaptor is configured to operatively engage with said closure. In an embodiment, said first and second adaptors are configured to together operatively engage with said closure. In an embodiment, said flanged end of the second adaptor includes an upper engagement surface on which at least a portion of said closure bears when said closure is attached thereto.

In an embodiment, the article further includes said closure for preventing fluid communication between the interior of the article and the environment exterior of the article. In an embodiment, said closure is formed of a combination of fibre reinforced polymer and suitable metal. For example, the metal may be stainless steel. In an embodiment, the fibre reinforced polymer includes carbon fibre reinforced polymer. In an embodiment, the closure includes a thermoplastic polymer lining. For example, the thermoplastic polymer lining may be polyethylene.

In an embodiment, the sealing device includes one or more sealing components. At least one of the one or more sealing components may be in the form of ring-shaped gasket.

In a preferred form, the article is a hollow composite vessel. The hollow composite vessel may be of generally spherical, cylindrical, spherocylindrical, rectangular, or any other shape generally known in the art.

In a second aspect, the present invention provides a method of producing a hollow composite vessel, the method including:
applying one or more fibrous materials to an internal surface of a hollow mould, the hollow mould including structure protruding away from an interior of the mould;
heating and rotating the hollow mould in the presence of one or more thermoplastic polymers within the hollow mould so that the polymer melts and at least partially infiltrates the fibrous material;
cooling the mould so that the thermoplastic polymer solidifies; and
releasing a hollow thermoplastic polymer/fibrous material composite vessel having structure protruding away from an interior of the vessel from the mould.

Advantageously, the present invention enables the production of a hollow composite vessel having a substantially thermoplastic inner/first layer, with a substantially fibrous second layer. The fibrous second layer can act as a suitable coupling layer adapted to enable further layers to be formed therewith. The thermoplastic inner layer can act as a barrier layer that is substantially impervious to material contacting the interior of the vessel. Furthermore, the integrally formed structure of the vessel is seamlessly integrated into the vessel with this same multilayer structure. Thus, there are no weld lines or joints present between the vessel and the integrally formed structure.

It is to be understood that reference to the thermoplastic polymer/fibrous material composite vessel is a reference to the hollow composite vessel when having only said fibrous material(s) and thermoplastic polymer(s) layers.

In an embodiment, the method further includes one or more of the following:
applying a plurality of filaments selected from one or more of carbon, glass, aramid and basalt filaments to the outside of the hollow thermoplastic polymer/fibrous material composite vessel wherein prior to application the plurality of filaments are at least partly wetted with one or more thermoset polymers;
applying a plurality of filaments selected from one or more of carbon, glass, aramid and basalt filaments to the outside of the hollow thermoplastic polymer/fibrous material composite vessel followed by application of one or more thermoset polymers;
applying one or more thermoset polymers to the outside of the hollow thermoplastic polymer/fibrous material composite vessel followed by application of a plurality of filaments selected from one or more of carbon, glass, aramid and basalt filaments.

Advantageously, the provision of this additional layer(s) to the outside of the hollow thermoplastic polymer/fibrous material composite vessel results in increased strength of the produced hollow composite vessel. The fibrous layer of the hollow thermoplastic polymer/fibrous material composite vessel facilitates coupling of this additional layer(s) thereto. Preferably, application of this additional layer(s) results in the one or more fibrous materials being at least partly infiltrated with both the one or more thermoplastic polymers and the one or more thermosetting polymers.

In an embodiment, said applying one or more fibrous materials to an internal surface of a hollow mould includes fastening the one or more fibrous materials to the internal surface of the hollow mould. The hollow mould may include fastening means (e.g. a fastening arrangement) to secure the one or more fibrous materials to the internal surface of the hollow mould. In an embodiment, the method further includes holding the one or more fibrous materials to the internal surface of a hollow mould whilst heating and rotating the hollow mould. For example, gas pressure may be used to hold the one or more fibrous materials to the internal surface of the hollow mould. This may be achieved by supplying a gas flow into an interior of a rotational moulding apparatus (where heating and rotating the hollow mould takes place), thereby applying a pressure differential across the one or more fibrous materials to force the one or more fibrous materials against the internal surface of the hollow mould. In an embodiment, a combination of gas pressure and a fastening arrangement may be employed to secure the one or more fibrous materials to the internal surface of the hollow mould.

Applying one or more fibrous materials to an internal surface of a hollow mould may include applying one or more of ceramic fibres and polymeric fibres. Said applying one or more ceramic fibres may include applying one or more of glass, carbon and basalt fibres, or precursors thereof. Said applying one or more polymeric fibres may include applying one or both synthetic polymers and natural polymers. The one or more polymeric fibres may comprise one or more of polyamide and polyolefin. Suitable polyolefins include polyethylene and polypropylene.

The one or more thermoplastic polymers may include one or more of ethylene homopolymers, ethylene co-polymers, propylene homopolymers, propylene co-polymers, fluoropolymers, polyvinylchloride, polyvinylidene chloride, polyaryl ether ketone (for example polyether ether ketone) and polyamide. The one or more thermoplastic polymers are preferably provided in powder form.

In an embodiment, the one or more fibrous materials include one or more fabricated textile materials. The one or more fabricated textile materials may include one or more of woven, knitted, and braided materials. The one or more fabricated textile materials comprise yarns of plied strands. In an embodiment, the spacing between at least some yarns of the fibrous material is from about 0.01 micron to about 5000 micron, or from about 0.1 micron to about 5000 micron, or between about 1 micron and about 5000 micron, or between about 10 micron and about 5000 micron.

The one or more thermosetting polymers may include one or more of vinyl ester, bismaleimide, polyester, polyacrylate, epoxy, and polyurethane.

In an embodiment, the plurality of filaments have a filament diameter from about 0.1 micron to about 500 micron, or from about 0.1 micron to about 100 micron, or from about 0.1 micron to about 50 micron, or from about 1 micron to about 20 micron.

In an embodiment, the plurality of filaments are in the form of one or more of wound filaments, fabric sections comprising multiple yarns, braided yarns, and chopped fibres.

In an embodiment, the thickness of the first layer is from about 0.1 mm to about 50 mm, the thickness of the second layer is from about 0.1 mm to about 5 mm, and the thickness of the additional layer(s) is from about 0.1 mm to about 1000 mm.

In an embodiment, thermoplastic polymer is embedded in gaps between yarns of the fibrous material of the second layer.

In an embodiment, thermoplastic polymer is embedded within the structure of individual yarns of the fibrous material of the second layer.

In an embodiment, tendrils of the fibrous material of the second layer extend from a surface of the yarns into the first layer.

In an embodiment, the thermoplastic polymer is not completely infiltrated across a thickness of the fibrous layer. That is to say, at least a portion of the surface of the fibrous layer is not fully penetrated by the thermoplastic polymer. Preferably, substantially all of the surface of the fibrous layer is not fully penetrated by the thermoplastic polymer.

Preferably, the structure of the vessel is configured to provide fluid communication between the interior of the vessel and an environment exterior of the vessel. The method may include boring or otherwise making one or more holes through the structure of the vessel and towards the interior of the vessel. Said one or more holes may provide said fluid communication between the interior of the vessel and the environment exterior of the vessel. Alternatively, the formed structure of the vessel may already be configured to provide said fluid communication between the interior of the vessel and the environment exterior of the vessel upon release from the mould.

The structure of the vessel may be one or more nozzles. The or each nozzle may be of the form described in the earlier aspect of the invention. As previously mentioned, the or each nozzle may respectively form one or more nozzles of the vessel or, in alternative embodiments, the or each nozzle is configured to receive one or more component parts that form one or more respective nozzles of the vessel.

In an embodiment, the method may include forming or shaping the structure of the vessel into one or more nozzles.

In an embodiment, the structure of the hollow mould protruding away from the interior of the mould is one or more nozzle mould portions adapted to produce one or more nozzles of the same form in the hollow composite vessel. The one or more nozzle mould portions may be integrally formed with the hollow mould. Alternatively, the method includes fixedly connecting the one or more nozzle mould portions to the hollow mould, thereby forming the structure of the hollow mould protruding away from the interior of the mould. Preferably, the one or more nozzle mould portions each include an internal flared region configured to form a corresponding flared region in the formed nozzle. The one or more nozzle mould portions are preferably adapted to include split lines in a plane subtended by an axial direction and a radial direction of the nozzle mould portions.

The flared region of the nozzle may be formed adjacent a nozzle opening of the formed nozzle. Alternatively, the flared region of the nozzle may be formed between the nozzle opening and the interior of the vessel.

In an embodiment, the method further includes forming or shaping the flared region into a flanged end of the nozzle.

In an embodiment, the method may further include reinforcing the or each nozzle with a fibre reinforced polymer and one or more thermosetting polymers, wherein the fibre reinforced polymer and the one or more thermosetting polymers are disposed on the one or more fibrous materials about the nozzle and the one or more fibrous materials is at least partly infiltrated with both the one or more thermoplastic polymers and the one or more thermosetting polymers.

In an embodiment, the method further includes forming a recess in an outer wall of the hollow thermoplastic polymer/fibrous material composite vessel about a periphery of the nozzle. The hollow mould may include a protrusion disposed about a periphery of the structure protruding towards the interior of the mould, thereby forming said recess extending through the outer wall of the hollow thermoplastic polymer/fibrous material composite vessel. Alternatively, said recess may be formed after the hollow thermoplastic polymer/fibrous material composite vessel is released from the mould.

In an embodiment, said boring or otherwise making one or more holes through the vessel includes making a hole through the vessel after applying the filament layer, wherein said hole is configured to receive one or more component parts that form a nozzle of the vessel. In an embodiment, the method further includes assembling said one or more component parts to from the nozzle of the vessel. In an embodiment, said assembling includes connecting a first adaptor to a respective one of said nozzles. In an embodiment, said assembling includes providing an adhesive or other attachment means between said first adaptor and said nozzle to facilitate said connection. In an embodiment, said assembling includes connecting a second adaptor to the respective one of said nozzles. Preferably said connecting includes receiving at least in part in the channel of the nozzle body the second adaptor. In an embodiment, said assembling includes providing a sealing device between the nozzle body and the second adaptor before connecting said second adaptor to said nozzle. In an embodiment, said assembling includes operatively engaging the first adaptor and the second adaptor. The first and second adaptors may be of the form described in the earlier aspect of the invention.

In an embodiment, the method further includes providing a closure for preventing fluid communication between the interior of the vessel and the environment exterior of the vessel. In an embodiment, providing said closure includes operatively engaging said closure with the first adaptor. In an embodiment, providing said closure includes operatively engaging said closure with the second adaptor. In an embodiment, providing said closure includes operatively engaging said closure with the first and second adaptors. In an embodiment, providing said closure includes operatively engaging said closure with said flanged end of the second adaptor, for example, the upper engagement surface thereof.

It will be appreciated that the second aspect of the invention can include any of the features defined with respect to the first aspect of the invention.

In a third aspect, the present invention provides a hollow composite vessel, having an inner wall defining an interior of the vessel and integrally formed structure with the inner wall, wherein the integrally formed structure protrudes away from the interior of the vessel, the vessel formed of a first layer including one or more thermoplastic polymers, and a second layer including one or more fibrous materials.

It will be appreciated that the third aspect of the invention can include any of the features defined with respect to the first and second aspects of the invention.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 shows a perspective view of a hollow composite vessel in accordance with an embodiment of the present invention;

FIG. 2 shows a cross section view of the hollow composite vessel of FIG. 1;

FIG. 3 shows a cross section view of part of a nozzle of the vessel, including showing the multilayer structure thereof;

FIG. 4 shows a cross section view of a nozzle in accordance with an embodiment of the invention;

FIG. 5 shows a cross section view of another nozzle in accordance with an embodiment of the invention;

FIG. 6 shows a cross section view of another nozzle in accordance with an embodiment of the invention;

FIG. 7 shows a perspective view of another hollow composite vessel in accordance with an embodiment of the present invention;

FIG. 8 shows a front section view of the hollow composite vessel of FIG. 7;

FIG. 9 shows a perspective view of another hollow composite vessel in accordance with an embodiment of the present invention;

FIG. 10 shows a cross section view of the hollow composite vessel of FIG. 9;

FIG. 11 shows a cross section view of part of a nozzle of a vessel, including showing the multilayer structure thereof;

FIG. 12 shows a cross section view of part of a nozzle of a vessel, including showing the multilayer structure thereof;

FIG. 13 shows a cross section view of part of a nozzle of the vessel, including showing the multilayer structure thereof;

FIG. 14 shows a cross section view of part of a nozzle of the vessel, including showing the multilayer structure thereof;

FIG. 15 shows a cross section view of part of a nozzle of the vessel, including showing the multilayer structure thereof;

FIG. 16 shows a cross section view of part of a nozzle of the vessel, including showing the multilayer structure thereof;

FIG. 17 shows a perspective, cross section view of part of a nozzle formed of component parts of a vessel of another embodiment;

FIG. 18 shows a perspective, cross section view of part of a nozzle formed of component parts of a vessel of another embodiment;

FIG. 19 shows a perspective, cross section view of part of a nozzle formed of component parts of a vessel of another embodiment;

FIG. 20 shows a front, cross section view of FIG. 17;

FIG. 21 shows a front, cross section view of a nozzle formed of component parts of a vessel of another embodiment; and

FIG. 22 shows a perspective, part cutaway view of a nozzle formed of component parts of a vessel of another embodiment.

### DETAILED DESCRIPTION OF THE EMBODIMENTS

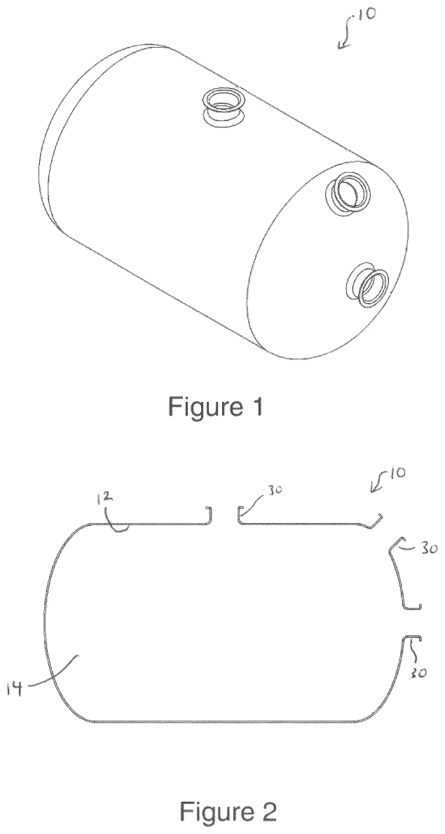

Reference is made to FIGS. 1-3, which depicts a roto-moulded article, in the form of a hollow composite vessel 10. As will be appreciated from the discussion below, vessel 10 is suitable for use in the containing and transporting of hazardous materials including chemicals and the like. However, it will be readily appreciated that vessel 10 can be used for containing and transporting non-dangerous goods, as well as being employed in analogous sectors such as construction of fuel and cargo tanks for transport vehicles, in aerospace applications, and also for the storage and transport of high pressure gas and cryogenic substances.

As will be described in further detail below, vessel 10 is formed in part by a rotational moulding process which, in the case of vessel 10, results in the formation of a multilayer structured vessel. As used herein, reference to a hollow thermoplastic polymer/fibrous material composite vessel (or similar) is a reference to the vessel produced as a direct result of a rotational moulding process, whilst reference to the hollow composite vessel (or similar) may in addition include reference to a modified form of the hollow thermoplastic polymer/fibrous material composite vessel. For example, in certain applications, additional layers are added after the rotational moulding process to the hollow thermoplastic polymer/fibrous material composite vessel in order to make the vessel suitable for such applications. Thus, for avoidance of doubt, hollow composite vessel 10 includes additional layer(s) that have been added to the hollow thermoplastic polymer/fibrous material composite vessel after the rotational moulding process. The multilayer structure will be described in further detail below.

In the depicted embodiment, vessel 10 is of substantially spherocylindrical shape. However, alternative vessel shapes may also be provided, such as cylindrical, rectangular, or any other shape generally known in the art.

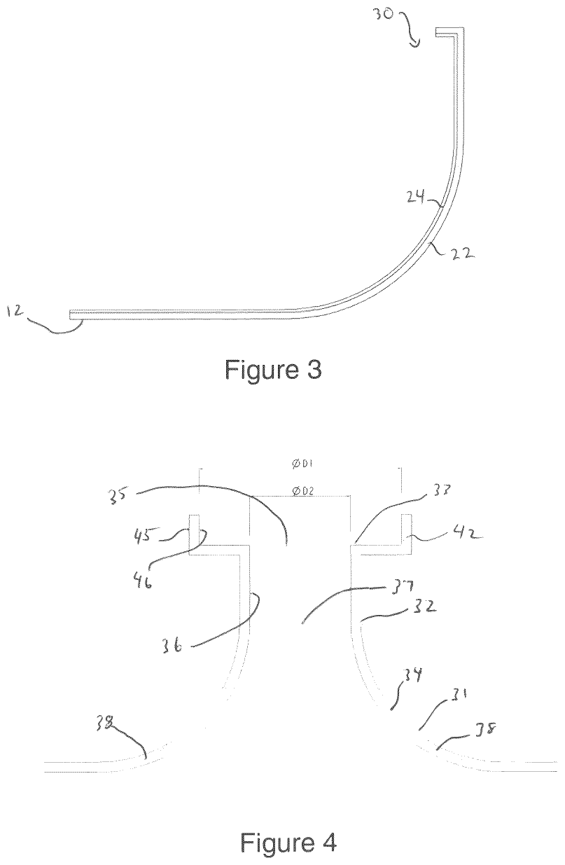

With reference to FIG. 2, vessel 10 includes an inner wall 12 defining an interior 14 of the vessel 10. Vessel 10 further includes integrally formed structure with the inner wall 12 in the form of a plurality of nozzles 30 protruding away from the interior 14 of the vessel 10. It will be appreciated from at least FIG. 3 that nozzles 30 of the vessel 10 are seamlessly integrated into the vessel 10 with the same multilayer structure as the rest of the vessel 10. Thus, there are no weld lines present between the vessel 10 and the nozzles 30. This is in stark contrast to known prior art vessel production, particularly in the case of polymer-based vessels, that usually require separate attachment of a pre-fabricated nozzle to a vessel. This often involves making a hole in the vessel, and then attaching (e.g. via welding or other fixation method) a nozzle to the hole. However, the present inventors have been able to successfully manufacture a vessel with an integrally formed nozzle, all formed of the same multilayer structure. This eliminates the need for post-vessel fabrication attachment of the nozzle, thereby resulting in the nozzle being seamlessly integrated into the overall structure of the vessel.

With reference to FIG. 4, nozzle 30 includes a substantially tubular nozzle body 32. Nozzle body 32 includes at a first, inner end 31, a nozzle base 34 formed with the inner wall 12 of the vessel 10 and, and at a second, outer end 33 thereof, a nozzle opening 35 configured to provide fluid communication between the interior 14 of the vessel 10 and the environment exterior of the vessel 10. Nozzle body 32 further includes an inner wall 36 defining a channel 37. Inner wall 36 of nozzle body 32 is arranged substantially parallel to a longitudinal axis of the nozzle when viewed in longitudinal cross section as shown in FIG. 4. Channel 37 is configured to provide fluid communication between the interior 14 of the vessel 10 and the nozzle opening 35.

It will be appreciated from the longitudinal cross section view of nozzle 30 in FIG. 4 that nozzle 30 is seamlessly integrated with inner wall 12 of vessel 10. As shown, nozzle base 34 defines a substantially curved base transition portion 38 between the inner wall 12 of vessel 10 and nozzle 30, thereby defining a smooth transition profile between inner wall 12 and the nozzle 30. A radius of curvature of the base transition portion 38 may be in the range of about 1 mm to about 1000 mm. The provision of base transition portion 38 enhances the manufacturability of vessel 10 with integrally formed nozzle 30. One of the challenges of manufacturing vessel 10, which is a hollow thermoplastic polymer/fibrous material composite, is ensuring that during the rotational moulding process, there is sufficient contact time between the thermoplastic polymer and the fibrous material across the entire hollow mould. As rotationally moulding a multilayer structure of complex shape presents many challenges, providing the hollow mould with correspondingly shaped portions to the substantially curved base transition 38 enhances the contact time between the thermoplastic polymer(s) and the fibrous material(s) around this complex portion of the mould.

In view of base transition portion 38, it will be appreciated that, at inner end 31, channel 37 is widest because a distance between opposed surfaces of inner wall 36 are widest. Inner wall 36 initially smoothly tapers inwardly towards outer end 33 until such point a distance between opposed surfaces of inner wall 36 becomes constant. As a result, a portion of channel 37 towards outer end 33 has a substantially constant transverse cross-section. It will be appreciated that channel 37 is of substantially circular shape in transverse cross-section. However, in other embodiments, the channel may be of another shape in transverse cross-section, such as square, oval, elliptical, and triangular.

Nozzle 30 includes a flared region, which in this embodiment is in the form of a flange 42 adjacent nozzle opening 35 and integrally formed as part of nozzle 30. Thus flange 42 will also be formed of the same multilayer structure as the rest of nozzle 30 and vessel 10 (as shown in FIG. 3). Flange 42 is arranged substantially concentric to the nozzle body 32. Flange 42 has a diameter ØD1 generally greater than a diameter of the nozzle body 32, in particular greater than a diameter ØD2 of the nozzle body 32 immediately adjacent flange 42. Flange 42 is configured to facilitate connection between nozzle 30 and one or more external components. Examples of components that may be connected to nozzle 30 via flange 42 include pipes, valves, sensors, and probes.

In the present embodiment, flange 42 includes an outer wall 45 and an inner wall 46. Outer wall 45 and/or inner wall 46 can be adapted for engagement with said one or more components. For example, the one or more components may be clamped onto, connected or otherwise bear against outer wall 45 and/or clamped into, connected or otherwise bear against inner wall 46. In some applications a fluidly sealed connection is desired with nozzle 30, in which case suitable sealing components may be provided between flange 42 and the one or more external components. Alternatively, flange 42 may itself be configured to facilitate fluidly sealed connection between nozzle 30 and one or more external components.

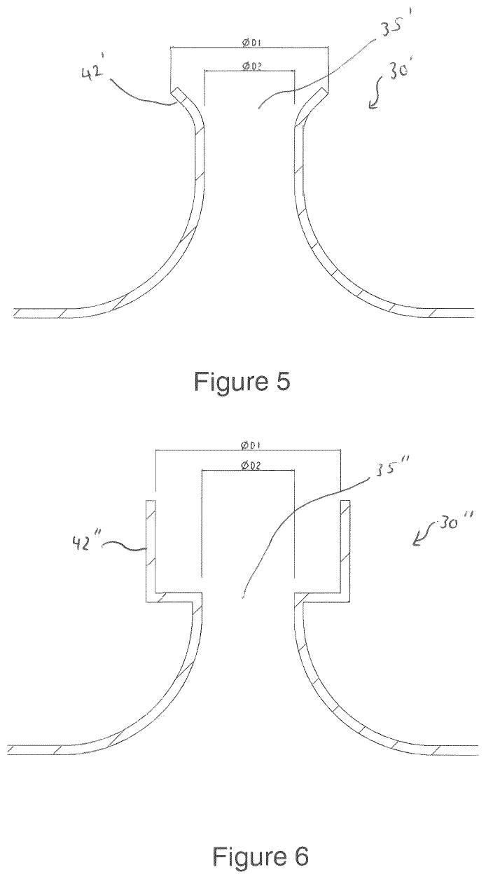

Reference is now made to FIG. 5, which provides an alternative embodiment of nozzle 30′. Nozzle 30′ is similar to nozzle 30 in many respects, and these similarities will not be discussed again here. The main difference between nozzle 30′ and nozzle 30 is that nozzle 30′ includes a flared end 42′ adjacent nozzle opening 35′ and integrally formed as part of nozzle 30′. Flared end 42′ has a diameter ØD1 generally greater than a diameter of the nozzle body 32′, in particular greater than a diameter ØD2 of the nozzle body 32′ immediately adjacent flared end 42′.

Reference is now made to FIG. 6, which provides another alternative embodiment of nozzle 30″. Nozzle 30″ is similar to nozzle 30 in many respects, and these similarities will not be discussed again here. The main difference between nozzle 30″ and nozzle 30 is that nozzle 30″ includes a relatively deeper flange 42″ adjacent nozzle opening 35″ and integrally formed as part of nozzle 30′. Flange 42″ has a diameter ØD1 generally greater than a diameter of the nozzle body 32″, in particular greater than a diameter ØD2 of the nozzle body 32″ immediately adjacent flared end 42′.

Whilst not shown in the accompanying figures, nozzles 30, 30′, 30″ are generally provided with a substantially curved nozzle transition portion between nozzle body 32, 32′, 32″ and flange/flared end 42, 42′, 42″, thereby defining a smooth transition profile between nozzle body 32, 32′, 32″ and flange/flared end 42, 42′, 42″. A radius of curvature of the nozzle transition portion may be in the range of about 1 mm to about 1000 mm. Thus, an external surface profile of nozzle 30, 30′, 30″ is substantially continuous with inner wall 12, i.e. a seamless transition between inner wall 12, nozzle body 32, 32′, 32″ and flange/flared end 42, 42′, 42″.

As will be appreciated from the embodiments above, each nozzle 30, 30′, 30″ is integrally formed with vessel 10, with the same multilayer structure, whereby each nozzle has a greater width dimension at the nozzle opening relative to the nozzle body. Challenges associated with the formation of a multilayered vessel having such a nozzle structure in a rotational moulding process have therefore been overcome by the present inventors through suitable design of the nozzle mould including having split lines in a plane subtended by an axial direction and a radial direction of the nozzle mould portions.

Returning to FIGS. 1 to 3, it will be appreciated that nozzle base 32 of each nozzle 30 is formed substantially with a tangent of the inner wall 12 of the vessel 10. However, this need not be the case.

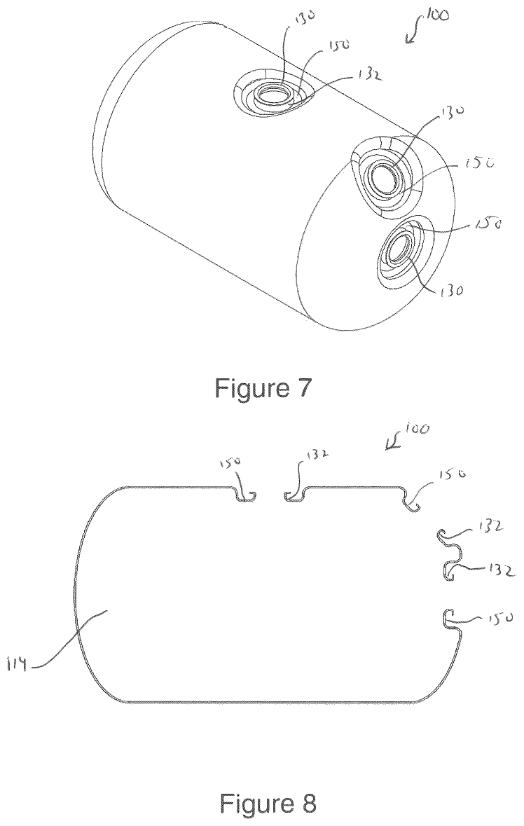

With reference to FIGS. 7 and 8, there is provided a vessel 100 having a plurality of recesses 150 directed towards the interior 114 of vessel 100. In this embodiment, each nozzle base 132 is formed at a base of each respective recess 150 such that each nozzle 130 is contained wholly within its respective recess 150. Such an arrangement is advantageous when exterior clearance around the vessel is limited and therefore does not permit space for the nozzle 130 and/or any components to be attached to nozzle 130.

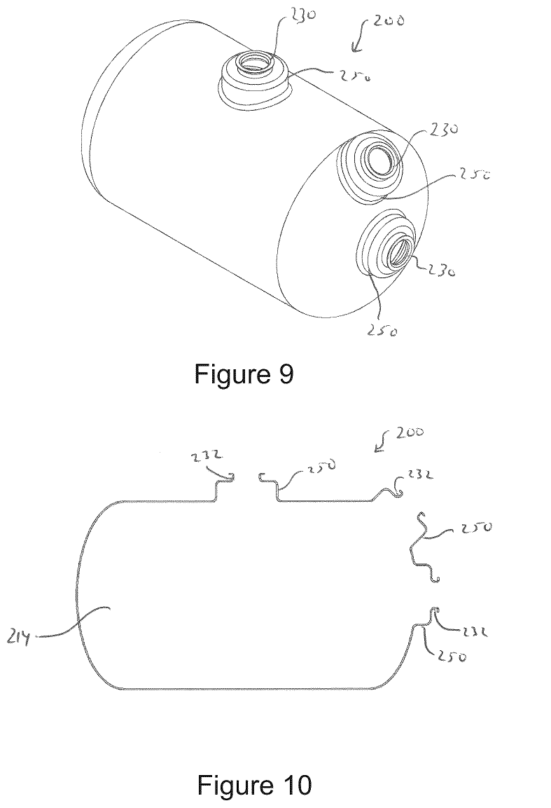

With reference to FIGS. 9 and 10, there is provided a vessel 200 having a plurality of protrusions 250 directed away from the interior 214 of vessel 200. In this embodiment, each nozzle base 232 is formed on each respective protrusion 250 such that each nozzle 230 extends from its respective protrusion 250. Such an arrangement can be advantageous in certain applications. For example, one suitable application is attachment of a closure to a sump placed at the lowest point of the vessel for drainage purposes.

It will be appreciated that whilst the depicted embodiments show vessels having multiple nozzles, in other embodiments the vessel can include a single nozzle. Further, as demonstrated by the depicted embodiments, a nozzle can be located at any location on the vessel (e.g. a nozzle can be located at any one or more of a barrel of the vessel, at the ends of the vessel, at an upper surface of the vessel, at a lower surface of the vessel, and at a side surface of the vessel).

Vessel 10 is formed of a multilayer structure including a first, inner layer 22 including one or more thermoplastic polymers, and a second layer 24 including one or more fibrous materials (best shown in FIG. 3). As a result of a rotational moulding process, which is explained in more detail below, the one or more fibrous materials are at least partly infiltrated with the one or more thermoplastic polymers. The thermoplastic polymer inner layer 22 acts as a barrier layer that is substantially impervious to material contacting the inner layer 22, whilst the fibrous outer layer 24 can act as a suitable coupling layer adapted to enable further layers to be formed therewith. Furthermore, nozzles 30 of vessel 10 are seamlessly integrated into vessel 10 with the same multilayer structure having the first and second layers. Thus, there are no weld lines present between vessel 10 and nozzles 30.

Thermoplastic polymers for use in the construction of first layer 22 preferably possess resistance to a variety of substances and conditions. For example, resistance to one or more of high pH, low pH, oxidising agents, reducing agents, solvents, high pressure gas, cryogenic substances, permeation, and abrasion.

The one or more thermoplastic polymers of first layer 22 can include one or more of ethylene homopolymers, ethylene co-polymers, propylene homopolymers, propylene co-polymers, fluoropolymers, polyvinylchloride, polyvinylidene chloride, polyaryl ether ketone (for example polyether ether ketone) and polyamide.

Suitable fluoropolymers include one or more of polyvinyl fluoride, polyvinylidene fluoride, polytetrafluorethylene, perfluoroalkoxy alkane, fluorinated ethylene-propylene, ethylene tetrafluoroethylene, ethylene chlorotrifluoroethylene, polyethylenetetrafluoroethylene, and polyethylenechlorotrifluoroethylene.

The one or more fibrous materials of the second layer 24 can include one or more of ceramic fibres and polymeric fibres.

Hollow thermoplastic polymer/fibrous material composite vessel 10 can be used in some applications without further modification. However, for other applications, it is preferred that vessel 10 be reinforced. Such reinforcement may be applied only to increase the strength and stiffness of nozzles 30, or to also increase the strength and stiffness of the whole of vessel 10.

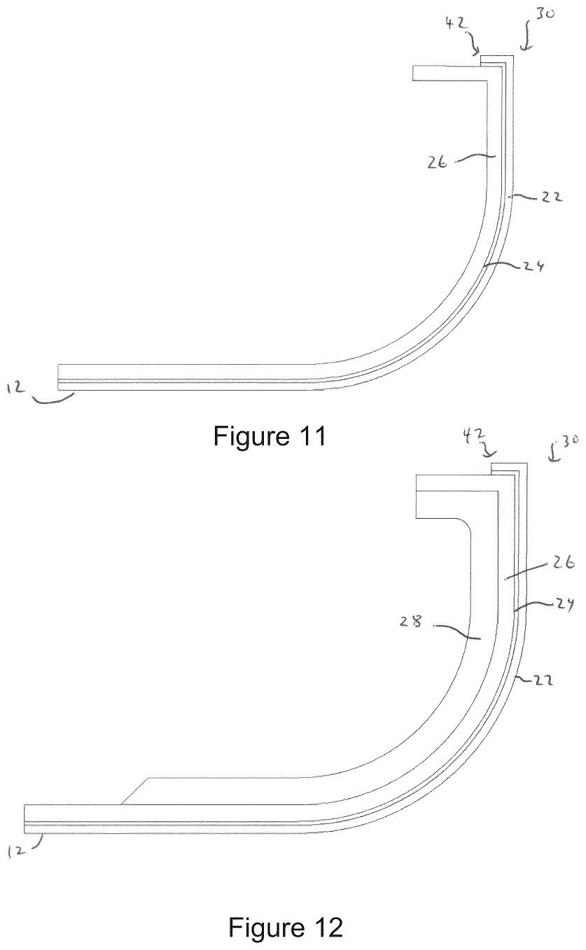

Reference is made to FIG. 11, which depicts reinforcement applied to increase the strength and stiffness of nozzle 30, including flange 42. In this embodiment, nozzle 30 is formed either substantially with a tangent of the inner wall 12 or is formed on a protrusion 250. Nozzle 30 is strengthened by providing a nozzle reinforcement layer 26 of a fibre reinforced polymer. This nozzle reinforcement layer 26 is applied onto the second layer 24 along the entirety of vessel 10 (to increase the strength and stiffness of the whole vessel 10) and along the entirety of nozzle 30, including flange 42. As a result of applying the nozzle reinforcement layer 26, the one or more fibrous materials of the second layer 24 is at least partly infiltrated with both the one or more thermoplastic polymers of inner layer 22 and the one or more thermosetting polymers of nozzle reinforcement layer 26.

Reference is made to FIG. 12, which depicts reinforcement applied to increase the strength and stiffness of nozzle 30, including flange 42. In this embodiment, nozzle 30 is formed either substantially with a tangent of the inner wall 12 or is formed on a protrusion 250. In much the same way as described with respect to FIG. 11, nozzle 30 is strengthened by providing a nozzle reinforcement layer 26 of a fibre reinforced polymer. This nozzle reinforcement layer 26 is applied onto the second layer 24 along the entirety of vessel 10 (to increase the strength and stiffness of the whole vessel 10) and along the entirety of nozzle 30, including flange 42. As a result of applying the nozzle reinforcement layer 26, the one or more fibrous materials of the second layer 24 is at least partly infiltrated with both the one or more thermoplastic polymers of inner layer 22 and the one or more thermosetting polymers of nozzle reinforcement layer 26. In the present embodiment, an additional reinforcement layer 28 is provided along the periphery of vessel 10 immediately adjacent nozzle 30, and along the entirety of nozzle 30, including flange 42.

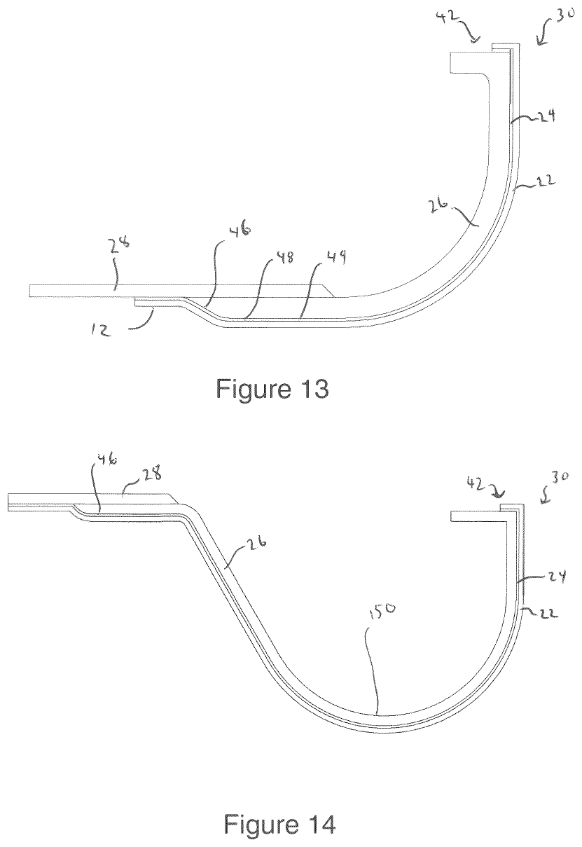

Reference is made to FIG. 13, which depicts reinforcement applied to increase the strength and stiffness of nozzle 30, including flange 42. In this embodiment, nozzle 30 is formed either substantially with a tangent of the inner wall 12 or is formed on a protrusion 250. Nozzle 30 is strengthened by providing a nozzle reinforcement layer 26 of a fibre reinforced polymer. This nozzle reinforcement layer 26 is applied onto the second layer 24 along the periphery of vessel 10 immediately adjacent nozzle 30, and along the entirety of nozzle 30, including flange 42. As shown in FIG. 13, vessel 10 includes an inset 46 provided about a periphery of nozzle 30. The inset 46 includes a base 48 adapted to facilitate engagement of vessel 10 to nozzle reinforcement layer 26 (as well as any subsequent layers applied to nozzle 30 and/or the remainder of vessel 10). The base 48 includes a substantially planar engagement surface 49 on which nozzle reinforcement layer 26 may bear. As a result of applying the nozzle reinforcement layer 26, the one or more fibrous materials of the second layer 24 is at least partly infiltrated with both the one or more thermoplastic polymers of inner layer 22 and the one or more thermosetting polymers of nozzle reinforcement layer 26. An outermost, reinforcement layer 28 of a fibre reinforced polymer can then be applied to the remainder of the vessel 10 to increase the strength and stiffness of the whole vessel 10.

Reference is now made to FIG. 14, which depicts reinforcement applied to increase the strength and stiffness of nozzle 30, including flange 42. In this embodiment, nozzle 30 is formed at a base of a recess 150 (similar to the embodiment of FIGS. 7 and 8). In much the same way as described with respect to FIG. 13, nozzle 30 is strengthened by providing a nozzle reinforcement layer 26 of a fibre reinforced polymer. This nozzle reinforcement layer 26 is applied onto the second layer 24 along the periphery of vessel 10 immediately adjacent nozzle 30 (in inset 46), along the peripheral walls of the recess 150, and along the entirety of nozzle 30, including flange 42. An outermost, reinforcement layer 28 of a fibre reinforced polymer can then be applied to the remainder of the vessel 10 to increase the strength and stiffness of the whole vessel 10.

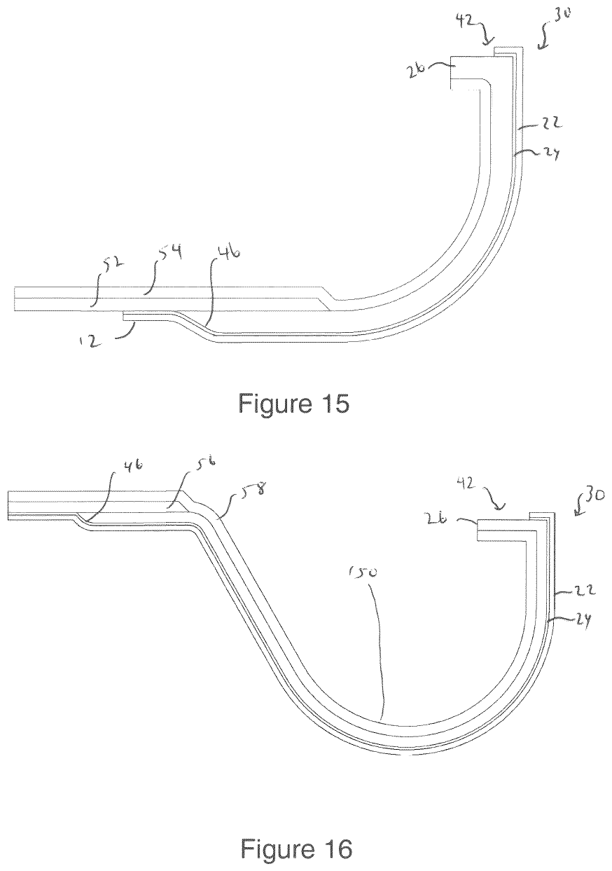

Reference is now made to FIG. 15, which depicts reinforcement applied to increase the strength and stiffness of nozzle 30, including flange 42. In this embodiment, nozzle 30 is formed either substantially with a tangent of the inner wall 12 or is formed on a protrusion 250. In much the same way as described with respect to FIG. 11, nozzle 30 is strengthened by providing a nozzle reinforcement layer 26 of a fibre reinforced polymer. This nozzle reinforcement layer 26 is applied onto the second layer 24 along the periphery of vessel 10 immediately adjacent nozzle 30 (in inset 46) and along the entirety of nozzle 30, including flange 42. In the present embodiment, further reinforcement layers are provided-a reinforcement layer 52 of a fibre reinforced polymer can be applied to the whole vessel 10 except for nozzle 30; and a reinforcement layer 54 that is applied along the whole periphery of vessel 10 including along the entirety of nozzle 30, including flange 42.

Reference is now made to FIG. 16, which depicts reinforcement applied to increase the strength and stiffness of nozzle 30, including flange 42. In this embodiment, nozzle 30 is formed at a base of a recess 150 (similar to the embodiment of FIGS. 7 and 8). In much the same way as described with respect to FIG. 15, nozzle 30 is strengthened by providing a nozzle reinforcement layer 26 of a fibre reinforced polymer. This nozzle reinforcement layer 26 is applied onto the second layer 24 along the periphery of vessel 10 immediately adjacent nozzle 30 (in inset 46) and along the entirety of nozzle 30, including flange 42. In the present embodiment, further reinforcement layers are provided-a reinforcement layer 56 of a fibre reinforced polymer can be applied to the whole vessel 10 except for nozzle 30; and a reinforcement layer 58 that is applied along the whole periphery of vessel 10 including along the entirety of nozzle 30, including flange 42.

Reinforcement layers can be applied to the thermoplastic polymer/fibrous material composite vessel in a number of ways. In one example, the reinforcement layers can be manually hand laid onto vessel 10. In another example, the reinforcement layers can be vacuum infused. In a further example, the reinforcement layers can involve: (1) filament winding one or more of carbon, glass, aramid and basalt filaments to the outside of the vessel 10 about nozzle 30 wherein prior to application, the filaments are at least partly wetted with one or more thermoset polymers; (2) filament winding one or more of carbon, glass, aramid and basalt filaments to the outside of the vessel 10 about nozzle 30 followed by application of one or more thermoset polymers; or (3) applying one or more thermoset polymers to the outside of the vessel 10 about nozzle 30 followed by filament winding one or more of carbon, glass, aramid and basalt filaments. As a result of applying the reinforcement layers the one or more fibrous materials of the second layer 24 is at least partly infiltrated with both the one or more thermoplastic polymers of the first layer 22 and the one or more thermosetting polymers of the reinforcement layers.

The one or more thermosetting polymers may include one or more of vinyl ester, bismaleimide, polyester, polyacrylate, epoxy, and polyurethane.

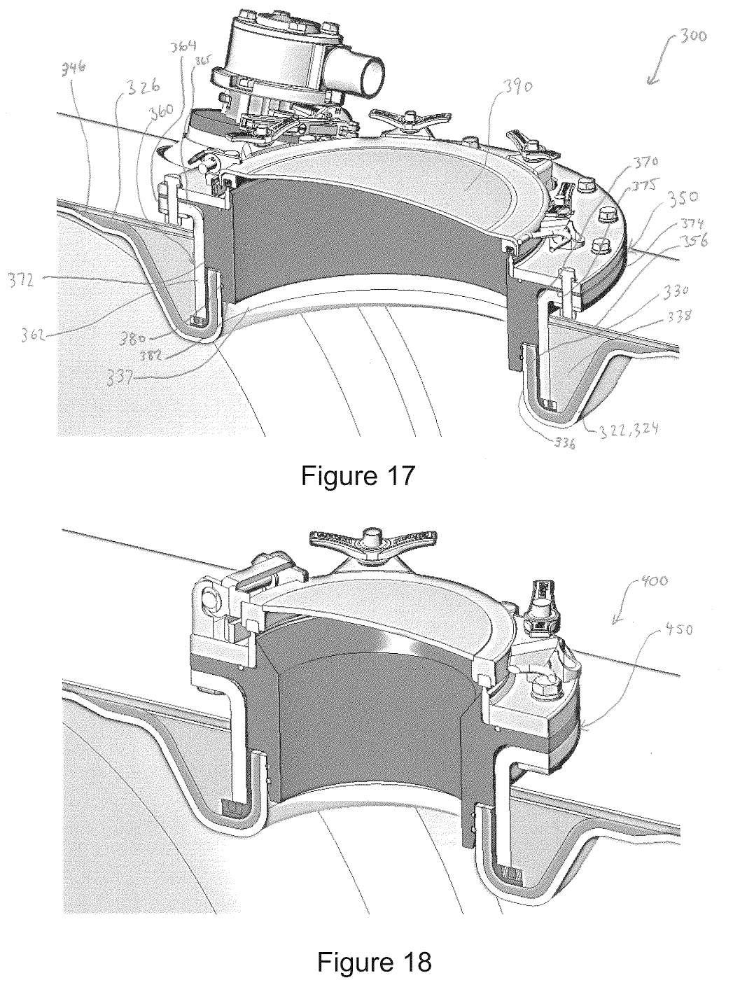

Reference is now made to FIG. 17, which depicts a nozzle 350 of vessel 300 that is formed of component parts. In this embodiment, spigot 330 is to be understood as the ‘nozzle’ or protruding structure formed during the rotational moulding process. Whilst not clearly delineated in FIG. 17, spigot 330 is formed of first layer 322 and second later 324 in a similar manner to earlier described embodiments. Also similar to earlier described embodiments, there is provided an inset 346 adapted to facilitate engagement of vessel 300 to nozzle reinforcement layer 326, as well as reinforcement layer 356 applied to the whole vessel 300 except for nozzle 350. A structural or non-structural filling material 338 or other bracing structure can be provided between nozzle reinforcement later 326 and reinforcement later 356 as shown in FIG. 17.

The component parts of nozzle 350 include a first adaptor 360 configured to be connected to an external surface of spigot 330. First adaptor 360 is formed of a carbon fibre reinforced polymer, although it will be appreciated that first adaptor 360 can be formed of other suitable materials. First adaptor 360 includes a substantially tubular adaptor body 362 and a flanged end 364. Flanged end 364 is arrange towards an exterior of vessel 300 when first adaptor 360 is connected to spigot 330. To facilitate suitable connection between first adaptor 360 and spigot 330, adhesive or other attachment means is provided.

The component parts of nozzle 350 further include a second adaptor 370 configured to be connected to an external surface of spigot 330. Second adaptor 370 is formed of a thermoplastic polymer, such a polyethylene, although it will be appreciated that second adaptor 370 can be formed of other suitable materials. Second adaptor 370 includes a substantially tubular adaptor body 372 and a flanged end 374. Flanged end 374 is arrange towards an exterior of vessel 300 when second adaptor 370 is connected to spigot 330. Whilst FIG. 17 shows first and second adaptors being of substantially the same shape, it will be appreciated that this need not be the case. An inner-facing portion (with respect to when second adaptor 370 is assembled to vessel 300) of adaptor body 372 is configured to be received within channel 337, which is defined by inner wall 336 of spigot 330. A sealing engagement between inner wall 336 and adaptor body 372 is formed by the provision of ring-shaped seals 380, which are provided in circumferential grooves 382 of adaptor body 362.

As best shown in FIG. 20, inner wall 336 is angled with respect to a longitudinal axis of spigot 330. In particular, inner wall 336 tapers slightly inwardly, thereby slightly reducing the inner diameter of channel 337. Inner wall 336 may be angled between about 1° and 89° with respect to the longitudinal axis of spigot 330 (it will be evident that in this embodiment, the angle is closer to the lower end of this range). Provision of angled inner wall 336 is advantageous as it accommodates the substantially radial load imparted by seal 380 and adaptor body 362 when adaptor body 362 is received within channel 337, thereby forming a suitable sealing engagement between the adaptor body 362 and spigot 330. However, it will be appreciated that in some embodiments, a face seal may be formed, whereby the face seal imparts a substantially axial load on inner wall 336.

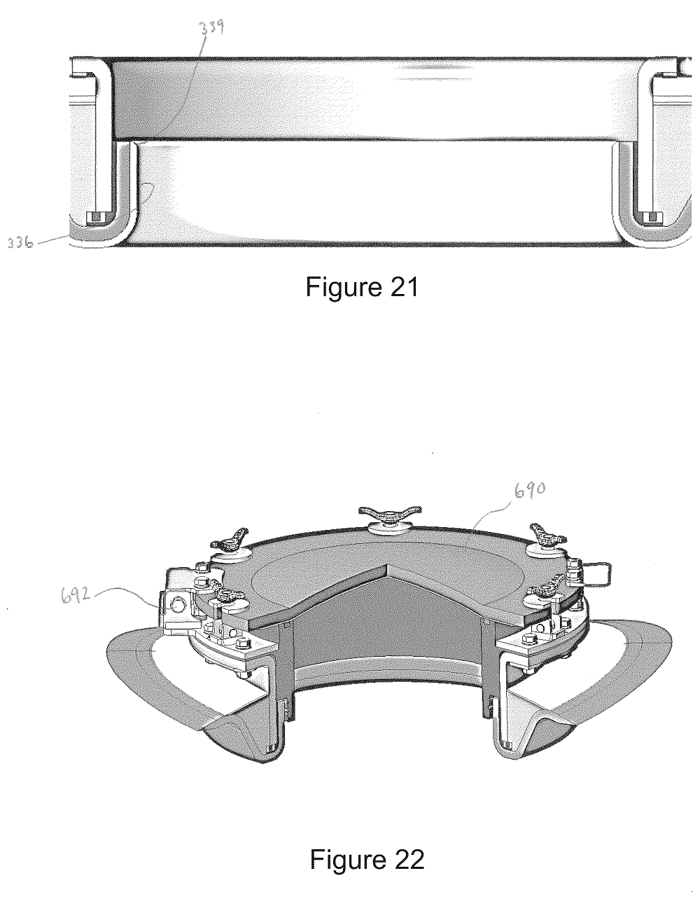

In another embodiment, as shown in FIG. 21, instead of having the entire inner wall 336 angled, a portion of inner wall 336 need only be angled. In this case, a chamfered end 339 is provided, wherein chamfered end 339 provides the slight inward taper. It will be appreciated that this embodiment may also be utilised in a face seal scenario, whereby the face seal imparts a substantially axial load on inner wall 336.

Returning to FIG. 17, second adaptor 370 is further configured to operatively engage with first adaptor 360. As shown, an upper engagement surface 365 of first adaptor 360 is configured to abut against a lower engagement surface 375 of second adaptor 370. Further, it will be appreciated that a portion of an inner surface of adaptor body 362 also engages with a portion of an outer surface of adaptor body 372 when first adaptor 360 and second adaptor 370 are assembled together.

Nozzle 350 is configured to enable assembly of a closure 390 thereto. Closure 390 is configured to prevent fluid communication between the interior of vessel 300 and the environment exterior of vessel 300. Closure 390 operatively engages both first adaptor 360 and second adaptor 370. In the embodiment shown, closure 390 is bolted to first adaptor 360 and second adaptor 370. When assembled to nozzle 350, closure 390 operatively engages with flanged end 374 of second adaptor 370, and when closure 390 is in a closed position shown in FIG. 17, a radially outer portion thereof bears against an upper engagement surface of flanged end 374. Other components may be provided to enable closure 390 to be attached to nozzle 350, as well as facilitate removal of closure 390, including moving of closure 390 from the closed position to an open positions (such as provision of suitable hinge 692 shown on closure 690 in FIG. 22). Nozzle 350 is therefore configured to facilitate a suitable fluidly sealed connection between vessel 300 and closure 390.

FIG. 17 (and FIG. 20) provide an example of how to implement a suitable manway opening for vessel 300.

Reference is now made to FIG. 18, which depicts a nozzle 450 of vessel 400 that is formed of component parts. The embodiment of FIG. 17 is very similar to the embodiment of FIG. 18, save for the overall size of respective spigots and nozzles. FIG. 18 provides an example of to how to implement a suitable cleaning hatch of vessel 400, which would typically be of smaller size relative to the manway of FIG. 17.

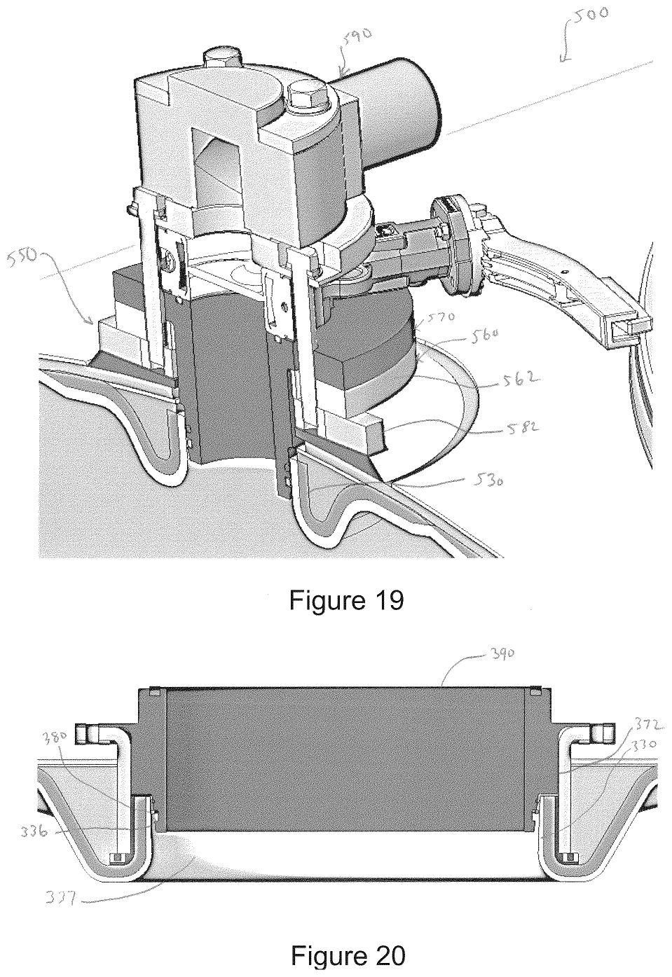

Reference is now made to FIG. 19, which depicts a nozzle 550 of vessel 500 that is formed of component parts. The embodiment of FIGS. 17 and 18 are very similar to the embodiment of FIG. 19, save for the overall size of respective spigots and nozzles, as well as some of the specific components. Unlike the embodiments of FIGS. 18 and 19, which provided examples of to how to incorporate closures on the vessels, the embodiment of FIG. 19 relates to incorporating instrumentation, such as sensors or probes 590. To this end, the configuration of first adaptor 560 is quite different to the configuration of second adaptor 570, which is still of substantially similar form as the second adaptor of the earlier embodiments. First adaptor 560 is in the form of a substantially ring-shaped flange 562, which is attached to vessel 500 using an adhesive or other attachment means, as well as flange nuts 582. Sensor 590 is bolted to nozzle 550, with the bolts going through second adaptor 570, first adaptor 560 and flange nuts 582. It will be appreciated that nozzle 550 and spigot 530 are typically of smaller size relative to the manway of FIG. 17 and the cleaning hatch of FIG. 18.

### Example Methods

One example of a suitable method to produce a hollow composite vessel 10 will now be described. However, it will be appreciated that alternative methods may also be employed.

The method involves preparation of the hollow mould for producing the hollow composite vessel. In the present embodiment, this involves suitable preparation of a plurality of hollow mould elements, which when assembled together form the mould of the whole hollow composite vessel. In the present example, the hollow mould elements include a generally cylindrical section and two end sections of generally hemispherical shape. The generally cylindrical section includes structure protruding away from an interior of the mould, said structure in the form of a nozzle mould portion. The nozzle mould portion may be an integrally formed part of a respective hollow mould element, or the nozzle mould portion may be formed of one or more separate components that can be suitably fixed to the respective hollow mould element. The hollow mould elements may be formed of a substantially steel frame.

A fibrous material is held by suitable fastening means, e.g. a suitable fastening arrangement, to an internal surface of each of the hollow mould elements, including the nozzle structure (where applicable). In the present example, a ceramic fibre is used. Whilst only one fibrous material has been applied to the internal surface of each of the hollow mould elements, it will be appreciated by a person skilled in the art that more fibrous materials could be used during this stage of the process (for example, by adhering further fibrous materials to the earlier fibrous material). Further, the specifically mentioned fibrous material used is to be taken as only exemplary, as alternative fibrous materials may be employed in this process. Whilst it is not necessary to have the same arrangement and type of fibrous material fastened to each hollow mould element, it is preferable in the formation of a homogenous and consistent hollow composite vessel.

Once each of the hollow mould elements have been prepared, the hollow mould elements are suitably assembled and fixed together to form the whole hollow composite vessel mould. The assembled mould is then inserted into the rotational moulding apparatus.

An example was demonstrated by placing about 75 kg of polyethylene powder into the rotational moulding apparatus prior to its closure. Gas pressure is used to hold the fibrous material layer to the internal surface of the whole composite vessel mould whilst the mould was undergoing rotation and conventional rotational mould heating. This is achieved by supplying a gas flow into an interior of the rotational moulding apparatus, thereby applying a pressure differential across the fibrous material to force the fibrous material against the internal surface of the mould.

Throughout the duration of the rotational moulding process, various rotational moulding parameters are considered and varied throughout the process to produce a suitable hollow composite vessel. These parameters include:
Mould temperature and methods of heating;
Rotational speed (about longitudinal axis) of rotational mould apparatus;
Tilt speed (about transverse axis) of rotational mould apparatus;
Tilt angle—maximum angle reached relative to longitudinal axis through rotation of mould apparatus about the transverse axis;
Pressure—pressure inside mould to help hold the fibrous layers to the internal surface of the mould and to maintain contact between the melting polyethylene and the fibrous layer; and
Timing—how long to hold certain parameters.

Throughout the process, care is taken in adjusting the rotational moulder apparatus set temperature, mould temperatures, and the pressure to ensure that a suitable ‘lay-up’ of polyethylene is established on the internal surface of the mould, particularly at the nozzle mould portion. As mentioned previously, the shaping of the nozzle mould portion has been carefully designed to ensure that contact time between the polyethylene and the nozzle mould portion is sufficient to produce moulded nozzles of suitable structural integrity in the produced hollow composite vessel.

Once the polyethylene has been suitably melted and dispersed, the rotational moulder apparatus set temperature is reduced and the heating turned off to allow the mould to cool so that the polyethylene solidifies. Once the temperature measured inside the mould is suitably low (and well below the melting point of the polyethylene powder), the pressure is released via an outlet valve. Towards the end of the process, rotation of the rotational mould apparatus about both longitudinal and transverse axes is halted. A hollow thermoplastic polymer/fibrous material composite vessel having structure (e.g. nozzle) protruding away from an interior of the vessel can then be released from the mould. It is noted that the nozzle mould structure is adapted to include split lines in a plane subtended by an axial direction and a radial direction of the nozzle mould portions to ensure proper release of the vessel.

Exterior examination of the vessel indicated that the fibrous layer was strongly affixed to the polyethylene by partial, but not complete, wet through of the polyethylene into the fibrous layer.

The next stage of the process involves the vessel, including the nozzle, being reinforced by applying a plurality of filaments selected from one or more of carbon, glass, aramid and basalt filaments to the outside of the hollow thermoplastic polymer/fibrous material composite vessel wherein prior to application the plurality of filaments are at least partly wetted with one or more thermosetting polymers. Thus, a hollow composite vessel is formed having increased strength and stiffness. The fibrous layer of the hollow thermoplastic polymer/fibrous material composite vessel facilitates coupling of the reinforcement layer thereto, thus resulting in the fibrous materials being at least partly infiltrated with both the one or more thermoplastic polymers and the one or more thermosetting polymers.

An example method will now be described with regards to embodiments where a nozzle is formed of component parts. A hole is made through the vessel, in a region about the nozzle/spigot, after applying the filament layer. An adhesive is then used to connect the first adaptor. The second adaptors is then provided, with a lower portion thereof received within the channel of the spigot, and in sealing engagement therewith. This creates the nozzle formed of component parts. A closure can then be bolted onto the nozzle.

It will be understood that the invention disclosed and defined in this specification extends to all alternative combinations of two or more of the individual features mentioned or evident from the text or drawings. All of these different combinations constitute various alternative aspects of the invention.

1. A hollow roto-moulded article, having an inner wall defining an interior of the article and integrally formed structure with the inner wall, the integrally formed structure protruding away from the interior of the article, the article formed of a first layer including one or more thermoplastic polymers, and a second layer including one or more fibrous materials.

2. The hollow roto-moulded article of claim 1, wherein the one or more fibrous materials is at least partly infiltrated with the one or more thermoplastic polymers.

3. The hollow roto-moulded article of claim 1 or 2, wherein the structure is configured to provide fluid communication between the interior of the article and an environment exterior of the article.

4. The hollow roto-moulded article of claim 3, wherein the structure includes one or more nozzles.

5. The hollow roto-moulded article of claim 4, wherein the or each nozzle includes a nozzle body having, at or towards a first end thereof, a nozzle base formed with the inner wall of the article and, at or towards a second end thereof, a nozzle opening configured to provide said fluid communication between the interior of the article and the environment exterior of the article.

6. The hollow roto-moulded article of claim 4 or 5, wherein the or each nozzle includes a substantially curved base transition portion between the inner wall of the article and the nozzle, thereby defining a smooth transition profile between the inner wall of the article and the nozzle.

7. The hollow roto-moulded article of claim 6, wherein a radius of curvature of the base transition portions is in the range of about 1 mm to about 1000 mm.

8. The hollow roto-moulded article of claim 5 or any one of claim 6 or 7 insofar as dependent thereon, wherein the or each nozzle includes a flared region adjacent the nozzle opening, whereby a diameter of the flared region is greater than a diameter of the nozzle body.

9. The hollow roto-moulded article of claim 8, wherein the flared region includes a flanged end configured to facilitate connection of one or more components to the article.

10. The hollow roto-moulded article of claim 5 or any one of claims 6 to 9 insofar as dependent thereon, wherein the or each nozzle base is formed with a tangent of a main wall of the article.

11. The hollow roto-moulded article of claim 5 or any one of claims 6 to 9 insofar as dependent thereon, wherein the article includes one or more recesses directed towards the interior of the article and the or each nozzle base is formed in a respective recess.

12. The hollow roto-moulded article of claim 11, wherein the or each nozzle substantially resides within its respective recess.

13. The hollow roto-moulded article of claim 5 or any one of claims 6 to 9 insofar as dependent thereon, wherein the article includes one or more protrusions directed away from the interior of the article and the or each nozzle base is formed on a respective protrusion.

14. The hollow roto-moulded article of any one of claims 4 to 13, wherein the article includes reinforcement to increase the strength and/or stiffness of the or each nozzle.

15. The hollow roto-moulded article of claim 14, wherein the or each nozzle is reinforced by a fibre reinforced polymer and one or more thermosetting polymers, wherein the fibre reinforced polymer and the one or more thermosetting polymers are disposed on the second layer about the nozzle and the one or more fibrous materials is at least partly infiltrated with both the one or more thermoplastic polymers and the one or more thermosetting polymers.

16. The hollow roto-moulded article of any one of the preceding claims, wherein the one or more thermoplastic polymers in the first layer include one or more of ethylene homopolymers, ethylene co-polymers, propylene homopolymers, propylene co-polymers, fluoropolymers, polyvinylchloride, polyvinylidene chloride, polyaryl ether ketone and polyamide.

17. The hollow roto-moulded article of any one of the preceding claims, wherein the one or more fibrous materials in the second layer include one or more of glass fibre, carbon fibre and basalt fibres, or precursors thereof.

18. The hollow roto-moulded article of any one of the preceding claims, wherein the article includes a third layer including a plurality of filaments selected from one or more of carbon, glass, aramid and basalt filaments, and one or more thermosetting polymers, wherein the second layer is disposed between the first layer and the third layer, and wherein the one or more fibrous materials is at least partly infiltrated with both the one or more thermoplastic polymers and the one or more thermosetting polymers.

19. The hollow roto-moulded article of claim 15 or 18, wherein the one or more thermosetting polymers of the third layer comprise one or more of vinyl ester, bismaleimide, polyester, polyacrylate, epoxy, and polyurethane.

20. The hollow roto-moulded article of any one of the preceding claims, wherein an inner wall of at least one of the one or more nozzles, or a portion of said inner wall, is angled with respect to a longitudinal axis of the nozzle, such that a channel defined by said inner wall, or said angled portion, is wider at an exterior facing end of the channel.

21. The hollow roto-moulded article of claim 21, wherein said angled inner wall, or said angled portion, defines a sealing surface configured to engage a sealing device.

22. The hollow roto-moulded article of any one of the preceding claims, wherein the or each nozzle is configured to receive one or more component parts that form one or more respective nozzles of the article.

23. The hollow roto-moulded article of claim 20, wherein the one or more component parts include include a first adaptor configured to be connected to a respective one of said nozzles, said first adaptor including a flanged end, wherein said first adaptor is configured to facilitate connection of external component(s) to the article.

24. The hollow roto-moulded article of claim 23, wherein the one or more component parts include include a second adaptor configured to be connected to a respective one of said nozzles, said second adaptor including a flanged end, wherein, the second adaptor is configured to operatively engage the first adaptor.

25. The hollow roto-moulded article of claim 24 when dependent on claim 20 or 21, wherein the second adaptor is configured to be received at least in part in a channel of the nozzle body, wherein the second adaptor is sealingly engaged with the angled inner wall or said angled portion, wherein a sealing device can be received between the second adaptor and the angled inner wall or angled portion.

26. The hollow roto-moulded article of claim 25, further including a closure for preventing fluid communication between the interior of the article and the environment exterior of the article.

27. The hollow roto-moulded article of any of the preceding claims, wherein the article is a hollow composite vessel.

28. A method of producing a hollow composite vessel, the method including:
applying one or more fibrous materials to an internal surface of a hollow mould, the hollow mould including structure protruding away from an interior of the mould;
heating and rotating the hollow mould in the presence of one or more thermoplastic polymers within the hollow mould so that the polymer melts and at least partially infiltrates the fibrous material;
cooling the mould so that the thermoplastic polymer solidifies; and
releasing a hollow thermoplastic polymer/fibrous material composite vessel having structure protruding away from an interior of the vessel from the mould.

29. The method of claim 28, further including one or more of the following:
applying a plurality of filaments selected from one or more of carbon, glass, aramid and basalt filaments to the outside of the hollow thermoplastic polymer/fibrous material composite vessel wherein prior to application the plurality of filaments are at least partly wetted with one or more thermoset polymers;
applying a plurality of filaments selected from one or more of carbon, glass, aramid and basalt filaments to the outside of the hollow thermoplastic polymer/fibrous material composite vessel followed by application of one or more thermoset polymers;
applying one or more thermoset polymers to the outside of the hollow thermoplastic polymer/fibrous material composite vessel followed by application of a plurality of filaments selected from one or more of carbon, glass, aramid and basalt filaments.

30. The method of claim 29, wherein the one or more thermosetting polymers include one or more of vinyl ester, bismaleimide, polyester, polyacrylate, epoxy, and polyurethane.

31. The method of any one of claims 28 to 30, wherein applying one or more fibrous materials to an internal surface of a hollow mould includes applying one or more of glass fibre, carbon fibre and basalt fibres, or precursors thereof.

32. The method of any one of claims 28 to 31, wherein the one or more thermoplastic polymers include one or more of ethylene homopolymers, ethylene co-polymers, propylene homopolymers, propylene co-polymers, fluoropolymers, polyvinylchloride, polyvinylidene chloride, polyaryl ether ketone and polyamide.

33. The method of any one of claims 28 to 32, further including boring one or more holes through the structure of the vessel and towards the interior of the vessel.

34. The method of any one of claims 28 to 33, wherein the structure of the vessel is configured to provide fluid communication between the interior of the vessel and an environment exterior of the vessel.

35. The method of any one of claim 34, wherein the structure of the vessel includes one or more nozzles.

36. The method of any one of claims 28 to 35, wherein the hollow mould includes one or more protrusions directed towards the interior of the mould, the or each protrusion forming a respective recess in the formed vessel, the structure protruding away from the interior of the mould extending into the protrusion, thereby a base of the or each nozzle being formed in the respective recess of the formed vessel.

37. The method of any one of claims 28 to 35, wherein the hollow mould includes one or more protrusions directed away from the interior of the mould, the or each protrusion forming a respective protrusion in the formed vessel, the structure protruding away from the interior of the mould extending from the protrusion, thereby a base of the or each nozzle being formed on the respective protrusion of the formed vessel.

38. The method of any one of claims 28 to 37, further including reinforcing the or each nozzle with a fibre reinforced polymer and one or more thermosetting polymers, wherein the fibre reinforced polymer and the one or more thermosetting polymers are disposed on the one or more fibrous materials about the nozzle and the one or more fibrous materials is at least partly infiltrated with both the one or more thermoplastic polymers and the one or more thermosetting polymers.

39. The method of any one claims 28 to 38, wherein the structure of the hollow mould protruding into the interior of the mould is one or more nozzle mould portions.

40. The method of any one of claims 28 to 39, wherein the hollow mould further includes a protrusion disposed about a periphery of the structure protruding into an interior of the mould, wherein the hollow thermoplastic polymer/fibrous material composite vessel thereby includes a recess extending through an outer wall of the thermoplastic polymer/fibrous material composite, the recess disposed about a periphery of the structure.

41. The method of any one of claims 28 to 40, wherein an inner wall of at least one of the one or more nozzles, or a portion of said inner wall, is angled with respect to a longitudinal axis of the nozzle, such that a channel defined by said inner wall, or said angled portion, is wider at an exterior facing end of the channel.

42. The method claim 41, wherein said angled inner wall, or said angled portion, defines a sealing surface configured to engage a sealing device.

43. The method of claim 29 or any one of claims 30 to 42 insofar as dependent on claim 29, further including boring or otherwise making one or more holes through the vessel, wherein said making a hole through the vessel is undertaken after applying the filament layer, wherein said hole is configured to receive one or more component parts that form a nozzle of the article.

44. The method of claim 43, further including assembling said one or more component parts to from the nozzle of the vessel.

45. The method of claim 44, wherein said assembling includes connecting a first adaptor to a respective one of said nozzles, and connecting a second adaptor to the respective one of said nozzles.

46. The method of claim 45, wherein said assembling includes providing a sealing device between the nozzle and the second adaptor before connecting said second adaptor to said nozzle.

47. The method of any one of claims 28 to 46, further including providing a closure for preventing fluid communication between the interior of the vessel and the environment exterior of the vessel.
